(19) United States
(12) Patent Application Publication
(10) Pub. No.: US 2019/0236099 A1
(43) Pub. Date: Aug. 1, 2019

(54) PICTURE PROCESSING METHOD AND APPARATUS, AND ELECTRONIC DEVICE

(71) Applicant: Beijing Kingsoft Internet Security Software Co., Ltd., Beijing (CN)

(72) Inventor: Zhenlong GUO, Beijing (CN)

(21) Appl. No.: 16/074,366

(22) PCT Filed: Dec. 23, 2016
(86) PCT No.: PCT/CN2016/111766

§ 371 Date: Jul. 31, 2018

(30) Foreign Application Priority Data
Feb. 3, 2016 (CN) 201610077485.3

(51) Int. Cl. G06F 16/58; G06F 16/538; G06F 16/51

(52) U.S. Cl. CPC G06F 16/5866; G06F 16/51; G06F 16/538

(57) ABSTRACT

A picture processing method and apparatus, and an electronic device are disclosed. The method comprises: traversing a stored preset picture library to determine a tag for each of at least one reference picture in the preset picture library, wherein the tag is configured for identifying content of the reference picture, and a predetermined favorite operation has been performed on the at least one reference picture by a user (S101); determining at least one to-be-recommended tag from the determined tags according to a preset selecting rule (S102); sending the at least one to-be-recommended tag to a server, which is configured to provide a target picture to the electronic device (S103); and receiving and displaying a target picture that is provided by the server to the electronic device based on the at least one to-be-recommended tag (S104). The method can intelligently provide a user with more favorite pictures according to the user's preference.

The present application claims the priority to a Chinese Patent Application No. 201610077485.3, filed with the State Intellectual Property Office of the People's Republic of China, Feb. 3, 2016 and entitled “PICTURE PROCESSING METHOD AND APPARATUS, AND ELECTRONIC DEVICE”, which is incorporated herein by reference in its entirety.

### TECHNICAL FIELD

The present application relates to the field of computer applications, and in particular, to a picture processing method, a picture processing apparatus, and an electronic device.

### BACKGROUND

Nowadays, more and more people use electronic devices to browse pictures. In order to meet people's needs, various picture browsing are springing out constantly. When browsing pictures, people often want to browse more favorite pictures according to their own preferences.

However, if people want to browse more pictures of their favorite categories when using existing picture browsing softwares to browse pictures, they often have to manually search for the pictures of their favorite categories, and then browse them. These processes are often cumbersome and thus reduce the user experience.

Therefore, how to intelligently provide users with more pictures of their favorite categories based on their preferences is a problem that must be solved.

### SUMMARY

The embodiments of the present application disclose a picture processing method, a picture processing apparatus, and an electronic device, which can solve the problem of how to intelligently provide a user with more favorite pictures according to the user's preference. The specific solution is as follows.

In a first aspect, an embodiment of the present application provides a picture processing method which is applicable to an electronic device. The method includes:

traversing a stored preset picture library to determine a tag for each of at least one reference picture in the preset picture library, wherein the tag is configured for identifying content of the reference picture, and a predetermined favorite operation has been performed on the at least one reference picture by a user;

determining at least one to-be-recommended tag from the determined tags according to a preset selecting rule;

sending the at least one to-be-recommended tag to a server, which is configured to provide a target picture to the electronic device; and

receiving and displaying a target picture that is provided by the server to the electronic device based on the at least one to-be-recommended tag.

Optionally, before traversing a stored preset picture library, the picture processing method provided by an embodiment of the present application further includes:

obtaining, from a local picture library, at least one reference picture on which the predetermined favorite operation has been performed by the user, wherein the predetermined favorite operation includes an operation of giving a like and/or the number of times that a picture is opened exceeding a threshold; and

storing the at least one reference picture into the preset picture library.

Optionally, before traversing a stored preset picture library, the picture processing method provided by an embodiment of the present application further includes:

extracting reference target content of the at least one reference picture in the preset picture library;

determining a tag for the reference target content of each of the at least one reference picture based on a preset correspondence between target content and tags; and

marking each of the at least one reference picture with the tag.

Optionally, before traversing a stored preset picture library, the picture processing method provided by an embodiment of the present application further includes:

extracting reference target content of the at least one reference picture in the preset picture library;

matching the reference target content of each of the at least one reference picture with preset picture content for preset picture categories in a preset picture category database;

determining a preset picture category for preset picture content that matches the reference target content of each of the at least one reference picture as a picture category categories of the at least one reference picture; and

marking each of the at least one reference picture with a tag corresponding to the determined picture category.

Optionally, determining at least one to-be-recommended tag from the determined tags according to a preset selecting rule, includes:

categorizing and counting the at least one reference picture in the preset picture library according to the tags for the at least one reference picture in the preset picture library to obtain the number of pictures in each tag; and

determining a tag in which the number of pictures exceeds a predetermined threshold as the at least one to-be-recommended tag.

Optionally, after determining a tag in which the number of pictures exceeds a predetermined threshold as the at least one to-be-recommended tag, the picture processing method provided by the embodiment of the present application further includes:

determining a tag-level of each of the at least one to-be-recommended tag according to the number of pictures in this to-be-recommended tag, wherein the number of pictures in each of the at least one to-be-recommended tag is proportional to the tag-level of this to-be-recommended tag; and

sending the tag-level of each of the at least one to-be-recommended tag to the server.

Optionally, the tag includes:

at least one of a human tag, a landscape tag, an animal tag, a thing tag, an event tag, a geographical location tag, and a generation time tag.

In a second aspect, an embodiment of the present application provides a picture processing method which is applicable to a server. The method includes:

receiving at least one to-be-recommended tag sent by an electronic device, wherein the at least one to-be-recommended tag is configured for identifying content of at least one reference picture, and a predetermined favorite operation has been performed on the at least one reference picture by a user;

determining, from a candidate picture library storing candidate pictures marked with tags, a candidate picture marked with a tag that matches the at least one to-be-recommended tag as a target picture, according to the at least one to-be-recommended tag, wherein the tags are configured for identifying content of the candidate pictures; and

sending the target picture to the electronic device.

Optionally, before determining, from a candidate picture library storing candidate pictures marked with tags, a candidate picture marked with a tag that matches the at least one to-be-recommended tag as a target picture, the picture processing method provided by an embodiment of the present application further includes:

obtaining a candidate picture;

extracting reference target content of the candidate picture;

determining a tag for the reference target content of the candidate picture based on a preset correspondence between target content and tags; and

marking the candidate picture with the determined tag.

Optionally, before determining, from a candidate picture library storing candidate pictures marked with tags, a candidate picture marked with a tag that matches the at least one to-be-recommended tag as a target picture, the picture processing method provided by an embodiment of the present application further includes:

obtaining a candidate picture;

extracting reference target content of the candidate picture;

matching the reference target content of the candidate picture with preset picture content for preset picture categories in a preset picture category database;

determining a preset picture category for preset picture content that matches the reference target content of each of the at least one reference picture as a picture category categories of the at least one reference picture; and

marking the candidate picture with a tag corresponding to the determined picture category.

Optionally, the picture processing method provided by an embodiment of the present application further includes:

receiving a tag-level of each of the at least one to-be-recommended tag sent by the electronic device; and

determining, from a candidate picture library storing candidate pictures marked with tags, a candidate picture marked with a tag that matches the at least one to-be-recommended tag as a target picture, according to the at least one to-be-recommended tag, includes:

according to the at least one to-be-recommended tag and the tag-level of each of the at least one to-be-recommended tag, determining, from the candidate picture library storing candidate pictures marked with tags, a candidate picture marked with a tag that matches at least one to-be-recommended tag with a tag-level greater than a predetermined tag-level as a target picture.

Optionally, the picture processing method provided by an embodiment of the present application further includes:

receiving a tag-level of each of the at least one to-be-recommended tag sent by the electronic device; and

the target picture comprises a plurality of target pictures, and sending the target picture to the electronic device includes:

determining, according to the tag-level of each of the at least one to-be-recommended tag, an order that the target pictures are sent;

sending the target pictures to the electronic device according to the order.

In a third aspect, an embodiment of the present application provides a picture processing apparatus which is applicable to an electronic device. The apparatus includes: a tag determining module, a to-be-recommended tag determining module, a tag sending module, and a picture receiving and displaying module;

the tag determining module is configured for traversing a stored preset picture library to determine a tag for each of at least one reference picture in the preset picture library, wherein the tag is configured for identifying content of the reference picture, and a predetermined favorite operation has been performed on the at least one reference picture by a user;

the to-be-recommended tag determining module is configured for determining at least one to-be-recommended tag from the determined tags according to a preset selecting rule;

the tag sending module is configured for sending the at least one to-be-recommended tag to a server, which is configured to provide a target picture to the electronic device; and

the picture receiving and displaying module is configured for receiving and displaying a target picture that is provided by the server to the electronic device based on the at least one to-be-recommended tag.

Optionally, the picture processing apparatus provided by an embodiment of the present application further includes: a picture obtaining module and a picture storage module;

the picture obtaining module is configured for: before the stored preset picture library is traversed, obtaining, from a local picture library, at least one reference picture on which the predetermined favorite operation has been performed by the user, wherein the predetermined favorite operation includes an operation of giving a like and/or the number of times that a picture is opened exceeding a threshold; and

the picture storage module is configured for storing the at least one reference picture into the preset picture library.

Optionally, the picture processing apparatus provided by an embodiment of the present application further includes: a first content extracting module, a first tag determining module, and a first tag marking module, wherein

the first content extracting module is configured for extracting reference target content of the at least one reference picture in the preset picture library, before the stored preset picture library is traversed;

the first tag determining module is configured for determining a tag for the reference target content of each of the at least one reference picture based on a preset correspondence between target content and tags; and

the first tag marking module is configured for marking each of the at least one reference picture with the tag.

Optionally, the picture processing apparatus provided by an embodiment of the present application further includes: a second content extracting module, a matching module, a category determining module and a second tag marking module, wherein

the second content extracting module is configured for extracting reference target content of the at least one reference picture in the preset picture library, before the stored preset picture library is traversed;

the matching module is configured for matching the reference target content of each of the at least one reference picture with preset picture content for preset picture categories in a preset picture category database;

the category determining module is configured for determining a preset picture category for preset picture content that matches the reference target content of each of the at least one reference picture as a picture category categories of the at least one reference picture; and

the second tag marking module is configured for marking each of the at least one reference picture with tags corresponding to the determined picture category.

Optionally, the to-be-recommended tag determining module includes: a category and count unit and a to-be-recommended tag determining unit;

the category and count unit is configured for categorizing and counting the at least one reference picture in the preset picture library according to the tags for the at least one reference picture in the preset picture library to obtain the number of pictures in each tag; and

the to-be-recommended tag determining unit is configured for determining a tag in which the number of pictures exceeds a predetermined threshold as the at least one to-be-recommended tag.

Optionally, the picture processing apparatus provided by an embodiment of the present application further includes: a level determining module and a level sending module;

the level determining module is configured for: after the to-be-recommended tag determining unit determines a tag in which the number of pictures exceeds a predetermined threshold as the at least one to-be-recommended tag, determining a tag-level of each of the at least one to-be-recommended tag according to the number of pictures in this to-be-recommended tag, wherein the number of pictures in each of the at least one to-be-recommended tag is proportional to the tag-level of this to-be-recommended tag; and

the level sending module is configured for sending the tag-level of each of the at least one to-be-recommended tag to the server.

In a fourth aspect, an embodiment of the present application provides a picture processing apparatus which is applicable to a server. The apparatus includes: a to-be-recommended tag receiving module, a picture determining module, and a picture sending module;

the to-be-recommended tag receiving module is configured for receiving at least one to-be-recommended tag sent by an electronic device, wherein the at least one to-be-recommended tag is configured for identifying content of at least one reference picture, and a predetermined favorite operation has been performed on the at least one reference picture by a user;

the picture determining module is configured for determining, from a candidate picture library storing candidate pictures marked with tags, a candidate picture marked with a tag that matches the at least one to-be-recommended tag as a target picture, according to the at least one to-be-recommended tag, wherein the tags are configured for identifying content of the candidate pictures; and

the picture sending module is configured for sending the target picture to the electronic device.

Optionally, the picture processing apparatus provided by an embodiment of the present application further includes: a first candidate picture obtaining module, a third content extracting module, a third tag determining module, and a third tag marking module;

the first candidate picture obtaining module is configured for obtaining a candidate picture;

the third content extracting module is configured for extracting reference target content of the candidate picture;

the third tag determining module is configured for determining a tag for the reference target content of the candidate picture based on a preset correspondence between target content and tags; and

the third tag marking module is configured for marking the candidate picture with the determined tag.

Optionally, the picture processing apparatus provided by an embodiment of the present application further includes: a second candidate picture obtaining module, a fourth content extracting module, a second matching module, a second category determining module, and a fourth tag marking module;

the second candidate picture obtaining module is configured for obtaining a candidate picture;

the fourth content extracting module is configured for extracting reference target content of the candidate picture;

the second matching module is configured for matching the reference target content of the candidate picture with preset picture content for preset picture categories in a preset picture category database;

the second category determination module is configured for determining a preset picture category for preset picture content that matches the reference target content of each of the at least one reference picture as a picture category categories of the at least one reference picture; and

the fourth tag marking module is configured for marking the candidate picture with a tag corresponding to the determined picture category.

Optionally, the picture processing apparatus provided by an embodiment of the present application further includes: a first level receiving module;

the first level receiving module is configured for receiving a tag-level of each of the at least one to-be-recommended tag sent by the electronic device;

the picture determining module is configured for:

according to the at least one to-be-recommended tag and the tag-level of each of the at least one to-be-recommended tag, determining, from the candidate picture library storing candidate pictures marked with tags, a candidate picture marked with a tag that matches at least one to-be-recommended tag with a tag-level greater than a predetermined tag-level as a target picture.

Optionally, the picture processing apparatus provided by an embodiment of the present application further includes: a second level receiving module;

the second level receiving module is configured for receiving a tag-level of each of the at least one to-be-recommended tag sent by the electronic device; and

the picture sending module comprises a sending order determining unit and a picture sending unit, wherein the target picture includes a plurality of target pictures;

the sending order determining unit is configured for determining, according to the tag-level of each of the at least one to-be-recommended tag, an order that the target pictures are sent; and

the picture sending unit is configured for sending the target pictures to the electronic device according to the order.

In addition, an embodiment of the present application further provides an electronic device, comprising: a housing, a processor, a memory, a circuit board, and a power supply circuit, wherein the circuit board is arranged inside a space enclosed by the housing; the processor and the memory are arranged on the circuit board; the power supply circuit is configured to supply power to various circuits or components of the electronic device; the memory is configured to store executable program code; the processor executes a program corresponding to the executable program code by reading the executable program code stored in the memory so as to perform the following operations:

traversing a stored preset picture library to determine a tag for each of at least one reference picture in the preset picture library, wherein the tag is configured for identifying content of the reference picture, and a predetermined favorite operation has been performed on the at least one reference picture by a user;

determining at least one to-be-recommended tag from the determined tags according to a preset selecting rule;

sending the at least one to-be-recommended tag to a server, which is configured to provide a target picture to the electronic device; and

receiving and displaying a target picture that is provided by the server to the electronic device based on the at least one to-be-recommended tag.

In addition, an embodiment of the present application further provides a storage medium for storing an application program which, when executed, performs the picture processing method described in the embodiments of the present application, which includes:

traversing a stored preset picture library to determine a tag for each of at least one reference picture in the preset picture library, wherein the tag is configured for identifying content of the reference picture, and a predetermined favorite operation has been performed on the at least one reference picture by a user;

determining at least one to-be-recommended tag from the determined tags according to a preset selecting rule;

sending the at least one to-be-recommended tag to a server, which is configured to provide a target picture to the electronic device; and

receiving and displaying a target picture that is provided by the server to the electronic device based on the at least one to-be-recommended tag.

In addition, an embodiment of the present application further provides an application program which, when executed, performs the picture processing method described in the embodiments of the present application, which can include:

traversing a stored preset picture library to determine a tag for each of at least one reference picture in the preset picture library, wherein the tag is configured for identifying content of the reference picture, and a predetermined favorite operation has been performed on the at least one reference picture by a user;

determining at least one to-be-recommended tag from the determined tags according to a preset selecting rule;

sending the at least one to-be-recommended tag to a server, which is configured to provide a target picture to the electronic device; and

receiving and displaying a target picture that is provided by the server to the electronic device based on the at least one to-be-recommended tag.

In addition, an embodiment of the present application further provides a server, comprising: a housing, a processor, a memory, a circuit board, and a power supply circuit; wherein the circuit board is arranged inside a space enclosed by the housing; the processor and the memory are arranged on the circuit board; the power supply circuit is configured to supply power to various circuits or components of the server; the memory is configured to store executable program code; and the processor executes a program corresponding to the executable program code by reading the executable program code stored in the memory so as to perform the following operations:

receiving at least one to-be-recommended tag sent by an electronic device, wherein the at least one to-be-recommended tag is configured for identifying content of at least one reference picture, and a predetermined favorite operation has been performed on the at least one reference picture by a user;

determining, from a candidate picture library storing candidate pictures marked with tags, a candidate picture marked with a tag that matches the at least one to-be-recommended tag as a target picture, according to the at least one to-be-recommended tag, wherein the tags are configured for identifying content of the candidate pictures; and

sending the target picture to the electronic device.

In addition, an embodiment of the present application further provides a storage medium for storing an application program which, when executed, performs the picture processing method described in the embodiments of the present application, which includes:

receiving at least one to-be-recommended tag sent by an electronic device, wherein the at least one to-be-recommended tag is configured for identifying content of at least one reference picture, and a predetermined favorite operation has been performed on the at least one reference picture by a user;

determining, from a candidate picture library storing candidate pictures marked with tags, a candidate picture marked with a tag that matches the at least one to-be-recommended tag as a target picture, according to the at least one to-be-recommended tag, wherein the tags are configured for identifying content of the candidate pictures; and

sending the target picture to the electronic device.

In addition, an embodiment of the present application further provides an application program which, when executed, performs the picture processing method described in the embodiments of the present application, which includes:

receiving at least one to-be-recommended tag sent by an electronic device, wherein the at least one to-be-recommended tag is configured for identifying content of at least one reference picture, and a predetermined favorite operation has been performed on the at least one reference picture by a user;

determining, from a candidate picture library storing candidate pictures marked with tags, a candidate picture marked with a tag that matches the at least one to-be-recommended tag as a target picture, according to the at least one to-be-recommended tag, wherein the tags are configured for identifying content of the candidate pictures; and

sending the target picture to the electronic device.

In the embodiment of the present application, a stored preset picture library is first traversed to determine a tag for each of at least one reference picture in the preset picture library, wherein the tag is configured for identifying content of the reference picture, and a predetermined favorite operation has been performed on the at least one reference picture by the user; at least one to-be-recommended tag is determined from the determined tags according to a preset selecting rule; the at least one to-be-recommended tag is sent to a server, which is configured to provide a target picture to the electronic device; and the target picture that is provided by the server to the electronic device based on the at least one to-be-recommended tag is received and displayed. The target picture in the determined to-be-recommended tag can be recommended to the user according to the determined to-be-recommended tag, so as to intelligently provide the user with more favorite pictures according to his/her preference. Of course, not all of the advantages described above are required to implement any product or method of the present application.

### BRIEF DESCRIPTION OF THE DRAWINGS

In order to more clearly describe the technical solutions of the embodiments of the present application or of the prior art, drawings that need to be used in embodiments and the prior art will be briefly described below. Obviously, the drawings provided below are for only some embodiments of the present application; those skilled in the art can also obtain other drawings based on these drawings without any creative efforts.

FIG. 1 is a schematic flowchart of a picture processing method according to an embodiment of the present application;

FIG. 2 is another schematic flowchart of a picture processing method according to an embodiment of the present application;

FIG. 3 is a schematic structural diagram of a picture processing apparatus according to an embodiment of the present application;

FIG. 4 is another schematic structural diagram of a picture processing apparatus according to an embodiment of the present application;

FIG. 5 is a schematic structural diagram of an electronic device according to an embodiment of the present application.

### DETAILED DESCRIPTION

The embodiments of the present application will now be described in detail with reference to the accompanying drawings in the embodiments of the present application. Obviously, the described embodiments are only some, and not all, of the embodiments of the present application. All other embodiments obtained based on the embodiments of the present application by those skilled in the art without any creative efforts fall into the scope of protection defined by the present application.

The embodiments of the present application provide a picture processing method, a picture processing apparatus, and an electronic device, which can intelligently provide a user with more favorite pictures according to his/her preference.

In a first aspect, a picture processing method provided by an embodiment of the present application is described.

It should be noted that a picture processing method provided by an embodiment of the present application is applicable to an electronic device. The electronic device can include a desktop computer, a notebook computer, a tablet computer, a smart phone, or other tools that can browse pictures. Moreover, when performing the picture processing method provided by the embodiment of the present application, the electronic device must be connected to the network through a wireless connection, a wired connection, GPRS data communication, or the like, to receive and display recommended pictures through the network.

Certainly, a functional software for implementing the picture processing method provided by the embodiment of the present application may be a dedicated client software, or may be a plug-in for a picture browsing client software that cannot implement the recommendation of the user's favorite picture to the user according to the user's preference, or may be a plug-in for other camera client softwares with a camera function and a picture browsing function, and so on.

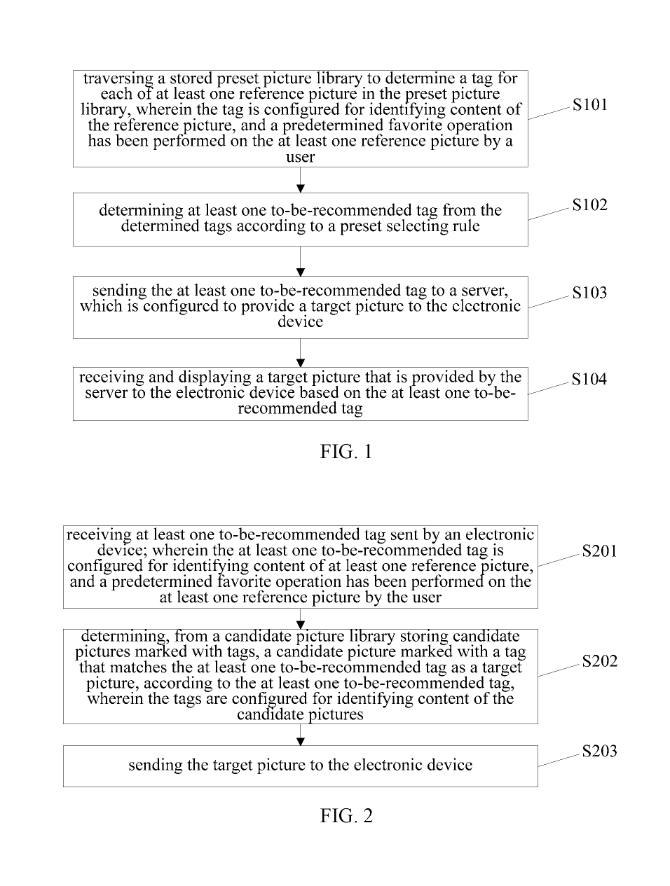

As shown in FIG. 1, the picture processing method provided by the embodiment of the present application may include S101-S104.

S101: traversing a stored preset picture library to determine a tag for each of at least one reference picture in the preset picture library, wherein the tag is configured for identifying content of the reference picture, and a predetermined favorite operation has been performed on the at least one reference picture by a user.

It can be understood, the electronic device stores a preset picture library, the preset picture library stores in advance pictures on which a predetermined favorite operation has been performed by a user, and at least one reference picture stored in the preset picture library is marked with a tag determined according to the content of the picture. Upon the user performs a preset operation on the electronic device to trigger the picture processing method provided by the embodiment of the present application, the electronic device traverses the stored preset picture library to determine a tag for each of at least one reference picture in the preset picture library. If the function software implementing the picture processing method provided by the embodiment of the present application is the dedicated client software, the preset operation may be an operation of starting the dedicated client software, such as double-clicking or clicking the startup icon, and the like. If the function software for implementing the picture processing method provided by the embodiment of the present application is a plug-in for other picture browsing or camera client softwares, the preset operation may be an operation of triggering the function of the picture processing method provided by the embodiment of the present application, such as double-clicking or clicking the function button, and the like.

S102: determining at least one to-be-recommended tag from the determined tags according to a preset selecting rule.

Specifically, after a tag for each of at least one reference picture in the preset picture library is determined, at least one to-be-recommended tag is determined from the determined tags for the at least one reference picture according to the preset selecting rule. The preset selecting rule may be that at least one tag having the most pictures can be determined as the at least one to-be-recommended tag, or that at least one tag in which the number of pictures exceeds a preset value can be determined as the at least one to-be-recommended tag, or that after the tags are sorted in descending order based on the number of their corresponding pictures, a tag before a preset position can be determined as the at least one to-be-recommended tag.

S103: sending the at least one to-be-recommended tag to a server, which is configured to provide a target picture to the electronic device;

After the at least one to-be-recommended tag has been determined, the determined at least one to-be-received tag is sent to the server over the network, so that the server provides a target picture to the electronic device according to the at least one to-be-recommended tag. The at least one to-be-recommended tag can be sent to the server by an existing technology, which will not described herein.

S104: receiving and displaying a target picture provided by the server to the electronic device based on the at least one to-be-recommended tag.

It should be noted that after receiving a target picture recommended by the server, the electronic device displays the target picture to the user. When there are at least two to-be-recommended tags, the electronic device can separately display target pictures recommended by the server according to the to-be-recommended tags. That is, the target pictures for the different to-be-recommended tags can be displayed in different areas on the electronic device; or a target picture in one of the to-be-recommended tags can be displayed first, and then a target picture in the other to-be-recommended tag is displayed. Of course, all target pictures can also be displayed together.

In the embodiment of the present application, a stored preset picture library is first traversed to determine a tag for each of at least one reference picture in the preset picture library, wherein the tag is configured for identifying content of the reference picture, and a predetermined favorite operation has been performed on the at least one reference picture by the user; at least one to-be-recommended tag is determined from the determined tags according to a preset selecting rule; the at least one to-be-recommended tag is sent to a server, which is configured to provide a target picture to the electronic device; and the target picture that is provided by the server to the electronic device based on the at least one to-be-recommended tag is received and displayed. The target picture in the determined to-be-recommended tag can be recommended to the user according to the determined to-be-recommended tag, so as to intelligently provide the user with more favorite pictures according to his/her preference.

Specifically, before traversing a stored preset picture library, the picture processing method provided by an embodiment of the present application can further include:

obtaining, from a local picture library, at least one reference picture on which the predetermined favorite operation has been performed by the user, wherein the predetermined favorite operation includes an operation of giving a like and/or the number of times that a picture is opened exceeding a threshold; and

storing the at least one reference picture into the preset picture library.

In practice, when a user browses the local picture library, the user can give a like to a picture according to his/her preference. The electronic device can store the picture in the preset picture library according to the user's operation of giving a like, and the electronic device can also store a picture whose opened times exceeds a threshold into the preset picture library. The picture whose opened times exceeds a threshold can be taken as a picture that the user likes.

Specifically, before traversing a stored preset picture library, the picture processing method provided by an embodiment of the present application can further include:

extracting reference target content of at least one reference picture in the preset picture library;

determining a tag for the reference target content of each of the at least one reference picture based on a preset correspondence between target content and tags; and

marking the at least one reference picture with the determined tags.

Specifically, reference target content of at least one reference picture is first extracted. The reference target content is the content mainly embodied in the at least one reference picture. The reference target content of the at least one reference picture can be determined by an existing technology. Similarly, the reference target content of the at least one reference picture can be extracted by an existing technology, which will not be described herein.

The electronic device stores in advance a preset correspondence between the target content and tags, and determines tags for the reference target content according to the preset correspondence, and accordingly marks the at least one reference picture with the tags.

In fact, based on the various contents shown in reference pictures, the reference pictures can be divided into human pictures, landscape pictures, animal pictures, cartoon pictures, and thing pictures. The landscape pictures can in fact be divided into pictures of different periods, such as spring, summer, autumn, winter and the like, or pictures of different geographical locations, such as United States, France, China and the like. The thing pictures can include cars of various models of various brands, and can also include the landmarks of various countries, and so on. Animal pictures can be divided into pictures of cute pets, such as dogs, cats, rabbits, hamsters and the like. Thus, according to various contents shown in reference pictures, the tags can include at least one of a human tag, a landscape tag, an animal tag, a thing tag, an event tag, a geographical location tag, and a generation time tag. One reference picture can have a plurality of tags, and one tag can have a plurality of reference pictures. There are reasonable.

It should be noted that when at least one reference picture is marked with a tag, a tag for the at least one reference picture can be determined according to a preset correspondence between target content and tags, or, it is possible to determine the picture category of the at least one reference picture according to the target content of the at least one reference picture, and then a tag for the at least one reference picture is determined according to the picture category of the at least one reference picture. Specifically, before traversing a stored preset picture library, the picture processing method provided by an embodiment of the present application can further include:

extracting reference target content of at least one reference picture in the preset picture library;

matching the reference target content of each of the at least one reference picture with preset picture content for preset picture categories in a preset picture category database;

determining a preset picture category for preset picture content that matches the reference target content of each of the at least one reference picture as a picture category categories of the at least one reference picture; and

marking each of the at least one reference picture with tags corresponding to the determined picture category.

Specifically, the electronic device stores the preset picture category database, and matches the extracted reference target content of the at least one reference picture with the preset picture content for the preset picture categories in the picture database, determines the picture categories of the at least one reference picture according to the reference target content of the at least one reference picture, and marks the at least one reference picture with tags corresponding to the determined picture categories.

There may be a plurality of implementations of determining the at least one to-be-recommended tag. One specific implementation is provided by this embodiment of the present application. Specifically, determining at least one to-be-recommended tag from the determined tags according to the preset selecting rule can include:

categorizing and counting the at least one reference picture in the preset picture library according to the tags for the at least one reference picture in the preset picture library to obtain the number of pictures in each tag; and

determining a tag in which the number of pictures exceeds a predetermined threshold as the at least one to-be-recommended tag.

It should be noted, after tags for at least one reference picture in the preset picture library are determined, the at least one reference picture in the preset picture library is categorized and counted according to the tags for the at least one reference picture in the preset picture library to obtain the number of pictures in each tag, determines a tag in which the number of pictures exceeds a predetermined value as at least one to-be-recommended tag. The predetermined value may be set by default by the electronic device, or may be set by the user. The implementation is merely an example. The embodiment of the present application does not limit the specific implementation of determining the at least one to-be-recommended tag.

Specifically, after determining a tag in which the number of pictures exceeds a predetermined threshold as the at least one to-be-recommended tag, the picture processing method provided by the embodiment of the present application can further include:

determining a tag-level for each of the at least one to-be-recommended tag according to the number of pictures of this to-be-recommended tag, wherein the number of pictures in each of the at least one to-be-recommended tag is proportional to the tag-level for this to-be-recommended tag; and sending the tag-level for each of the at least one to-be-recommended tag to the server.

It can be understood, according to the number of pictures in each of the at least one to-be-recommended tag, a user's preference degree for the pictures of the at least one to-be-recommended tag can be determined, and a tag-level can then be determined for each of the at least one to-be-recommended tag. In the at least one to-be-recommended tag, the greater the number of pictures of a to-be-recommended tag is, the higher the tag-level for the to-be-recommended tag is. To this end, the tag-level can represent the user's preference degree for the at least one to-be-recommended tag. After sending the tag-levels to the server, the server can recommend target pictures to the electronic device according to the tag-levels, which is reasonable.

In a second aspect, as shown in FIG. 2, an embodiment of the present application further provides a picture processing method, which is applicable to a server. This method can include S201-S203.

S201: receiving at least one to-be-recommended tag sent by an electronic device, wherein the at least one to-be-recommended tag is configured for identifying content of at least one reference picture, and a predetermined favorite operation has been performed on the at least one reference picture by a user.

It can be understood, after the server receives the at least one to-be-recommended tag sent by the electronic device, the server may select a target picture according to the at least one to-be-recommended tag, and then recommend the target picture to the electronic device. The at least one to-be-recommended tag is configured for identifying the content of the at least one reference picture, and a predetermined favorite operation has been performed on the at least one reference picture by the user.

S202: determining, from a candidate picture library storing candidate pictures marked with tags, a candidate picture marked with a tag that matches the at least one to-be-recommended tag as a target picture, according to the at least one to-be-recommended tag, wherein a tag for marking a candidate picture is configured for identifying content of the candidate picture.

It should be noted, the tags of at least one reference picture in the preset picture library are set in the electronic device according to the content of the picture. The tags of candidate pictures in the candidate picture library stored on the server are set by the server according to the content of the candidate pictures. In order to ensure the consistency of the tags, the electronic device and the server have to set tags for the pictures according to a same rule. After receiving at least one to-be-received tag sent by the electronic device, the server obtains candidate pictures, and determines, from a candidate picture library, a candidate picture marked with a tag that matches the at least one to-be-recommended tag as the target picture. The candidate pictures can be obtained by an existing technology, which will not be described herein.

S203: sending the target picture to the electronic device.

The target picture is determined according to the at least one to-be-recommended tag, and the target picture has been marked with a tag. When a target picture is sent to the electronic device, the target picture may be categorized and sent according to the tag of the target picture. The target picture can be sent by an existing technology, which will not be described herein.

In the embodiment of the present application, the server first receives at least one to-be-recommended tag sent by the electronic device, determines, from a candidate picture library storing candidate pictures marked with tags, a candidate picture marked a tag that matches the at least one to-be-recommended tag as a target picture, according to the at least one to-be-recommended tag; and sends the target picture to the electronic device. This can intelligently provide the user with more favorite pictures according to the user's preference.

Specifically, in order to recommend more extensive target pictures to the user, the categories and the number of candidate pictures in the candidate picture database can be increased. Before determining, from a candidate picture library storing candidate pictures marked with tags, a candidate picture marked with a tag that matches the at least one to-be-recommended tag as a target picture, the picture processing method provided by the embodiment of the present application can further include:

obtaining a candidate picture;

extracting reference target content of the candidate picture;

determining a tag for the reference target content of the candidate picture based on a preset correspondence between target content and tags; and

marking the candidate picture with the tag.

Certainly, obtaining a candidate picture and marking the candidate picture with a tag may be performed by the server after receiving the to-be-recommended tag. Furthermore, a candidate picture may be obtained regularly or irregularly by the server from the network. This is all possible. However, in consideration of the time, in order to more quickly recommend pictures to the user and provide better services for the user, the server can preferably obtain a candidate picture from the network regularly or irregularly, and extract reference target content of the candidate picture, and mark the candidate picture with a tag based on the preset correspondence between target content and tags.

Specifically, it is possible to mark a candidate picture with a tag based on the preset correspondence between target content and tags, or according to the picture category of the candidate picture. Specifically, before determining, from a candidate picture library storing candidate pictures marked with tags, a candidate picture marked with a tag that matches the at least one to-be-recommended tag as a target picture, the picture processing method provided by the embodiment of the present application can further include:

obtaining a candidate picture;

extracting reference target content of the candidate picture;

matching the reference target content of the candidate picture with preset picture content for preset picture categories in a preset picture category database;

determining a preset picture category for preset picture content that matches the reference target content of each of the at least one reference picture as a picture category categories of the at least one reference picture; and

marking the candidate picture with a tag corresponding to the determined picture category.

Of course, no matter it is the preset correspondence between the target content and the tag or the preset picture category database, both the server and the electronic device operate based on the same rule. If the electronic device marks a picture with a tag according to a preset correspondence between the target content and tags, the server marks a picture with a tag according to the preset correspondence accordingly. Similarly, if the electronic device marks a picture with a tag according to a preset picture category database, the server marks a picture with a tag according to the preset picture category database accordingly.

Specifically, the electronic device can determine a tag-level of each of the at least one to-be-recommended tag according to the number of pictures having this to-be-recommended tag, and can send the tag-level to the server. The server can determine a target picture according to the tag-level and send the target picture to the electronic device. At this point, the picture processing method provided by the embodiment of the present application can further include:

receiving a tag-level of each of the at least one to-be-recommended tag sent by the electronic device;

determining, from a candidate picture library storing candidate pictures marked with tags, a candidate picture marked with a tag that matches the at least one to-be-recommended tag as a target picture, according to the at least one to-be-recommended tag, comprises:

according to the at least one to-be-recommended tag and the tag-level of each of the at least one to-be-recommended tag, determining, from the candidate picture library storing candidate pictures marked with tags, a candidate picture marked with a tag that matches at least one to-be-recommended tag with a tag-level greater than a predetermined tag-level as a target picture.

In practice, when a larger number of to-be-recommended tags are received, the server will send a large amount of target pictures, determined according to the to-be-recommended tags, to the electronic device. In this case, to better recommend the user's favorite picture to the user, after receiving a tag-level of the at least one to-be-recommended tag, the server may determine a target picture according to the at least one to-be-recommended tag and its tag-level, wherein the tag of the target picture matches the at least one to-be-recommended tag, and the tag-level of the tag exceeds the predetermined tag-level. The predetermined tag-level may be a certain tag-level, a range of tag-levels, or the like. There are reasonable.

Specifically, in order to better recommend favorite pictures to the user, improve the order of recommending pictures, and better improve the user experience, after the server receives the tag-level of each of the at least one to-be-recommended tag sent by the electronic device, when the target picture includes a plurality of target pictures, sending the target picture to the electronic device can include:

determining, according to the tag-level of each of the at least one to-be-recommended tag, an order that the target pictures are sent; and

sending the target pictures to the electronic device according to the order.

It should be noted, after receiving the tag-level, the server can determine the order that the target pictures are sent according to the tag-level of each of the at least one to-be-recommended tag, and send the target pictures to the electronic device according to the order. A target picture with a higher tag-level will be sent earlier. This can improve the order of sending pictures, so that the user gets his/her most favorite pictures at first, improving the user experience.

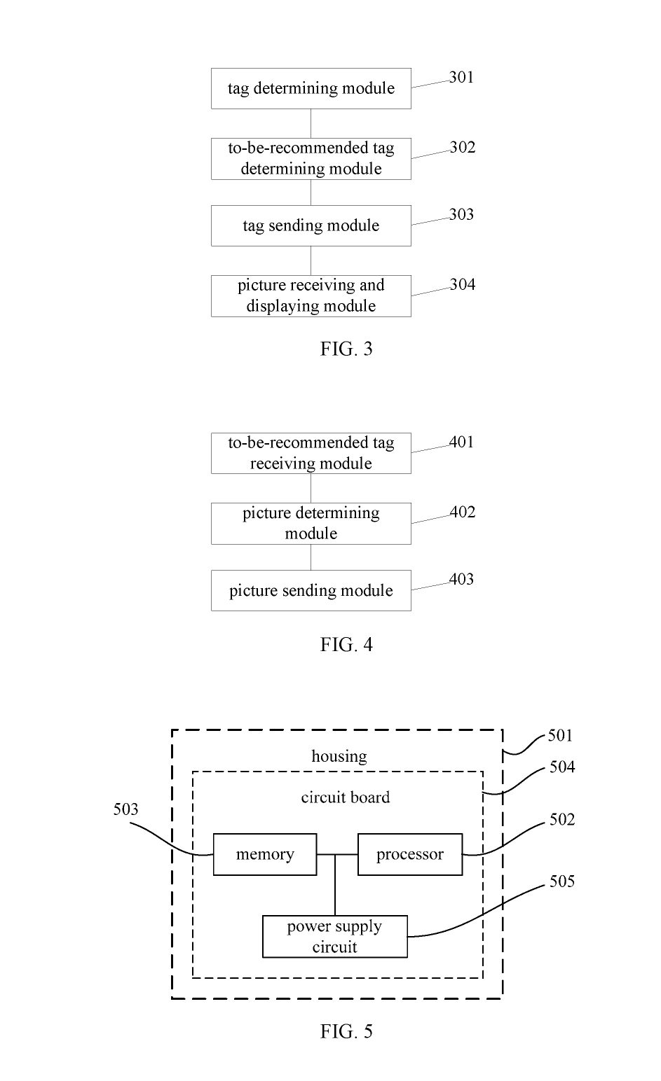

In a third aspect, corresponding to the foregoing method embodiment, as shown in FIG. 3, an embodiment of the present application further provides a picture processing apparatus which is applicable to an electronic device. The apparatus includes: a tag determining module 301, a to-be-recommended tag determining module 302, a tag sending module 303, and a picture receiving and displaying module 304;

the tag determining module 301 is configured for traversing a stored preset picture library to determine a tag for each of at least one reference picture in the preset picture library, wherein the tag are configured for identifying content of the at least one reference picture, and a predetermined favorite operation has been performed on the at least one reference picture by a user;

the to-be-recommended tag determining module 302 is configured for determining at least one to-be-recommended tag from the determined tags according to a preset selecting rule;

the tag sending module 303 is configured for sending the at least one to-be-recommended tag to a server, which is configured to provide a target picture to the electronic device; and

the picture receiving and displaying module 304 is configured for receiving and displaying a target picture that is provided by the server to the electronic device based on the at least one to-be-recommended tag.

In the embodiment of the present application, a stored preset picture library is first traversed to determine a tag for each of at least one reference picture in the preset picture library, wherein the tag is configured for identifying content of the reference picture, and a predetermined favorite operation has been performed on the at least one reference picture by the user; at least one to-be-recommended tag is determined from the determined tags according to a preset selecting rule; the at least one to-be-recommended tag is sent to a server, which is configured to provide a target picture to the electronic device; and the target picture that is provided by the server to the electronic device based on the at least one to-be-recommended tag is received and displayed. The target picture in the determined to-be-recommended tag can be recommended to the user according to the determined to-be-recommended tag, so as to intelligently provide the user with more favorite pictures according to his/her preference.

Specifically, the picture processing apparatus provided by an embodiment of the present application can further include: a picture obtaining module and a picture storage module;

the picture obtaining module is configured for: before the stored preset picture library is traversed, obtaining, from a local picture library, at least one reference picture on which the predetermined favorite operation has been performed by the user, wherein the predetermined favorite operation includes an operation of giving a like and/or the number of times that a picture is opened exceeding a threshold; and

the picture storage module is configured for storing the at least one reference picture into the preset picture library.

Specifically, the picture processing apparatus provided by an embodiment of the present application can further include: a first content extracting module, a first tag determining module, and a first tag marking module;

the first content extracting module is configured for extracting reference target content of the at least one reference picture in the preset picture library, before the stored preset picture library is traversed;

the first tag determining module is configured for determining a tag for the reference target content of each of the at least one reference picture based on a preset correspondence between target content and tags; and

the first tag marking module is configured for marking the at least one reference picture with the tags.

Specifically, the picture processing apparatus provided by an embodiment of the present application may further include: a second content extracting module, a matching module, a category determining module, and a second tag marking module;

the second content extracting module is configured for extracting reference target content of the at least one reference picture in the preset picture library, before the stored preset picture library is traversed;

the matching module is configured for matching the reference target content of each of the at least one reference picture with preset picture content for preset picture categories in a preset picture category database;

the category determining module is configured for determining a preset picture category for preset picture content that matches the reference target content of each of the at least one reference picture as a picture category categories of the at least one reference picture; and

the second tag marking module is configured for marking each of the at least one reference picture with a tag corresponding to the determined picture category.

Specifically, the to-be-recommended tag determining module 302 can include: a category and count unit and a to-be-recommended tag determining unit;

the category and count unit is configured for categorizing and counting the at least one reference picture in the preset picture library according to the tags for the at least one reference picture in the preset picture library to obtain the number of pictures in each tag; and

the to-be-recommended tag determining unit is configured for determining a tag in which the number of pictures exceeds a predetermined threshold as the at least one to-be-recommended tag.

Specifically, the picture processing apparatus provided by an embodiment of the present application can further include: a level determining module and a level sending module;

the level determining module is configured for: after the to-be-recommended tag determining unit determines a tag in which the number of pictures exceeds a predetermined threshold as the at least one to-be-recommended tag, determining a tag-level of each of the at least one to-be-recommended tag according to the number of pictures in this to-be-recommended tag, wherein the number of pictures in each of the at least one to-be-recommended tag is proportional to the tag-level of this to-be-recommended tag; and

the level sending module is configured for sending the tag-level of each of the at least one to-be-recommended tag to the server.

Specifically, the tag can include:

at least one of a human tag, a landscape tag, an animal tag, a thing tag, an event tag, a geographical location tag, and a generation time tag.

In a fourth aspect, corresponding to the foregoing method embodiment, as shown in FIG. 4, an embodiment of the present application further provides a picture processing apparatus which is applicable to a server. The apparatus includes: a to-be-recommended tag receiving module 401, a picture determining module 402, and a picture sending module 403;

the to-be-recommended tag receiving module 401 is configured for receiving at least one to-be-recommended tag sent by an electronic device, wherein the at least one to-be-recommended tag is configured for identifying content of at least one reference picture, and a predetermined favorite operation has been performed on the at least one reference picture by a user;

the picture determining module 402 is configured for determining, from a candidate picture library storing candidate pictures marked with tags, a candidate picture marked with a tag that matches the at least one to-be-recommended tag as a target picture, according to the at least one to-be-recommended tag, wherein the tags are configured for identifying content of the candidate pictures; and

the picture sending module 403 is configured for sending the target picture to the electronic device.

In the embodiment of the present application, the server first receives at least one to-be-recommended tag sent by the electronic device, determines, from a candidate picture library storing candidate pictures marked with tags, a candidate picture marked with a tag that matches the at least one to-be-recommended tag as a target picture, according to the at least one to-be-recommended tag; and sends the target picture to the electronic device. This can intelligently provide the user with more favorite pictures according to the user's preference.

Specifically, the picture processing apparatus provided by an embodiment of the present application can further include: a first candidate picture obtaining module, a third content extracting module, a third tag determining module, and a third tag marking module;

the first candidate picture obtaining module is configured for obtaining a candidate picture;

the third content extracting module is configured for extracting reference target content of the candidate picture;

the third tag determining module is configured for determining a tag for the reference target content of the candidate picture based on a preset correspondence between target content and tags; and

the third tag marking module is configured for marking the candidate picture with the determined tag.

Specifically, the picture processing apparatus provided by an embodiment of the present application can further include: a second candidate picture obtaining module, a fourth content extracting module, a second matching module, a second category determining module, and a fourth tag marking module;

the second candidate picture obtaining module is configured for obtaining a candidate picture;

the fourth content extracting module is configured for extracting reference target content of the candidate picture;

the second matching module is configured for matching the reference target content of the candidate picture with preset picture content for preset picture categories in a preset picture category database;

the second category determination module is configured for determining a preset picture category for preset picture content that matches the reference target content of each of the at least one reference picture as a picture category categories of the at least one reference picture; and

the fourth tag marking module is configured for marking the candidate picture with a tag corresponding to the determined picture category.

Specifically, the picture processing apparatus provided by an embodiment of the present application can further include: a first level receiving module;

the first level receiving module is configured for receiving a tag-level of each of the at least one to-be-recommended tag sent by the electronic device;

the picture determining module 402 is configured for:

according to the at least one to-be-recommended tag and the tag-level of each of the at least one to-be-recommended tag, determining, from the candidate picture library storing candidate pictures marked with tags, a candidate picture marked with a tag that matches at least one to-be-recommended tag with a tag-level greater than a predetermined tag-level as a target picture.

Specifically, the picture processing apparatus provided by an embodiment of the present application can further include: a second level receiving module;

the second level receiving module is configured for receiving a tag-level of each of the at least one to-be-recommended tag sent by the electronic device; and

the picture sending module 403 may comprise a sending order determining unit and a picture sending unit, wherein the target picture is a plurality of target pictures;

the sending order determining unit is configured for determining, according to the tag-level of each of the at least one to-be-recommended tag, an order that the target pictures are sent; and

the picture sending unit is configured for sending the target pictures to the electronic device according to the order.

In addition, an embodiment of the present application further provides an electronic device, as shown in FIG. 5. The electronic device can include: a housing 501, a processor 502, a memory 503, a circuit board 504, and a power supply circuit 505, wherein the circuit board 504 is arranged inside a space enclosed by the housing 501; the processor 502 and the memory 503 are arranged on the circuit board 504; the power supply circuit 505 is configured to supply power to various circuits or components of the electronic device; the memory 503 is configured to store executable program code; and the processor 502 executes a program corresponding to the executable program code by reading the executable program code stored in the memory 503 so as to perform the following operations:

traversing a stored preset picture library to determine a tag for each of at least one reference picture in the preset picture library, wherein the tag is configured for identifying content of the reference picture, and a predetermined favorite operation has been performed on the at least one reference picture by a user;

determining at least one to-be-recommended tag from the determined tags according to a preset selecting rule;

sending the at least one to-be-recommended tag to a server, which is configured to provide a target picture to the electronic device; and

receiving and displaying a target picture that is provided by the server to the electronic device based on the at least one to-be-recommended tag.

In the embodiment of the present application, a stored preset picture library is first traversed to determine a tag for each of at least one reference picture in the preset picture library, wherein the tag is configured for identifying content of the reference picture, and a predetermined favorite operation has been performed on the at least one reference picture by the user; at least one to-be-recommended tag is determined from the determined tags according to a preset selecting rule; the at least one to-be-recommended tag is sent to a server, which is configured to provide a target picture to the electronic device; and the target picture that is provided by the server to the electronic device based on the at least one to-be-recommended tag is received and displayed. The target picture in the determined to-be-recommended tag can be recommended to the user according to the determined to-be-recommended tag, so as to intelligently provide the user with more favorite pictures according to his/her preference.

The electronic device exists in various forms, including but not limited to:

(1) Mobile communication device: Such a device is characterized by its mobile communication function and mainly aims to provide voice and data communications. Such electronic devices include, for example, smart phones (such as iPhones), multimedia phones, functional mobile phones, and low-end mobile phones.

(2) Ultra-mobile personal computer device: Such a device belongs to the personal computer category, has calculation and processing functions, and generally has the mobile Internet features. Such electronic devices include: PDA, MID, and UMPC devices, and the like, such as the iPad.

(3) Portable Entertainment Device: Such a device can display and play multimedia content. Such devices include: audio and video players (such as iPods), handheld game consoles, e-books, and smart toys and portable car navigation devices.

(4) Other electronic devices that have data interaction capabilities.

In addition, an embodiment of the present application provides a storage medium, wherein the storage medium is used to store an application program. The application program is executed to perform the picture processing method according to the embodiments of the present application. The picture processing method provided by the embodiment of the present application can include:

traversing a stored preset picture library to determine a tag for each of at least one reference picture in the preset picture library, wherein the tag is configured for identifying content of the reference picture, and a predetermined favorite operation has been performed on the at least one reference picture by a user;

determining at least one to-be-recommended tag from the determined tags according to a preset selecting rule;

sending the at least one to-be-recommended tag to a server, which is configured to provide a target picture to the electronic device; and

receiving and displaying a target picture that is provided by the server to the electronic device based on the at least one to-be-recommended tag.

In the embodiment of the present application, a stored preset picture library is first traversed to determine a tag for each of at least one reference picture in the preset picture library, wherein the tag is configured for identifying content of the reference picture, and a predetermined favorite operation has been performed on the at least one reference picture by the user; at least one to-be-recommended tag is determined from the determined tags according to a preset selecting rule; the at least one to-be-recommended tag is sent to a server, which is configured to provide a target picture to the electronic device; and the target picture that is provided by the server to the electronic device based on the at least one to-be-recommended tag is received and displayed. The target picture in the determined to-be-recommended tag can be recommended to the user according to the determined to-be-recommended tag, so as to intelligently provide the user with more favorite pictures according to his/her preference.

In addition, an embodiment of the present application provides an application program which, when executed, performs the picture processing method according to the embodiments of the present application. The method can include:

traversing a stored preset picture library to determine a tag for each of at least one reference picture in the preset picture library, wherein the tag is configured for identifying content of the reference picture, and a predetermined favorite operation has been performed on the at least one reference picture by a user;

determining at least one to-be-recommended tag from the determined tags according to a preset selecting rule;

sending the at least one to-be-recommended tag to a server, which is configured to provide a target picture to the electronic device; and

receiving and displaying a target picture that is provided by the server to the electronic device based on the at least one to-be-recommended tag.

In the embodiment of the present application, a stored preset picture library is first traversed to determine a tag for each of at least one reference picture in the preset picture library, wherein the tag is configured for identifying content of the reference picture, and a predetermined favorite operation has been performed on the at least one reference picture by the user; at least one to-be-recommended tag is determined from the determined tags according to a preset selecting rule; the at least one to-be-recommended tag is sent to a server, which is configured to provide a target picture to the electronic device; and the target picture that is provided by the server to the electronic device based on the at least one to-be-recommended tag is received and displayed. The target picture in the determined to-be-recommended tag can be recommended to the user according to the determined to-be-recommended tag, so as to intelligently provide the user with more favorite pictures according to his/her preference.

In addition, an embodiment of the present application provides a server, comprising: a housing, a processor, a memory, a circuit board, and a power supply circuit; wherein the circuit board is arranged inside a space enclosed by the housing; the processor and the memory are arranged on the circuit board; the power supply circuit is configured to supply power to various circuits or components of the server; the memory is configured to store executable program code; and the processor executes the program corresponding to the executable program code by reading the executable program code stored in the memory so as to perform the following operations:

receiving at least one to-be-recommended tag sent by an electronic device, wherein the at least one to-be-recommended tag is configured for identifying content of at least one reference picture, and a predetermined favorite operation has been performed on the at least one reference picture by a user;

determining, from a candidate picture library storing candidate pictures marked with tags, a candidate picture marked with a tag that matches the at least one to-be-recommended tag as a target picture, according to the at least one to-be-recommended tag, wherein the tags are configured for identifying content of the candidate pictures; and

sending the target picture to the electronic device.

In the embodiment of the present application, the server first receives at least one to-be-recommended tag sent by the electronic device, determines, from a candidate picture library storing candidate pictures marked with tags, a candidate picture marked with a tag that matches the at least one to-be-recommended tag as a target picture, according to the at least one to-be-recommended tag; and sends the target picture to the electronic device. This can intelligently provide the user with more favorite pictures according to the user's preference.

In addition, an embodiment of the present application provides a storage medium for storing an application program which, when executed, performs the picture processing method according to the embodiments of the present application. The picture processing method provided by the embodiment of the present application can include:

receiving at least one to-be-recommended tag sent by an electronic device, wherein the at least one to-be-recommended tag is configured for identifying content of at least one reference picture, and a predetermined favorite operation has been performed on the at least one reference picture by a user;

determining, from a candidate picture library storing candidate pictures marked with tags, a candidate picture marked with a tag that matches the at least one to-be-recommended tag as a target picture, according to the at least one to-be-recommended tag, wherein the tags are configured for identifying content of the candidate pictures; and

sending the target picture to the electronic device.

In the embodiment of the present application, the server first receives at least one to-be-recommended tag sent by the electronic device, determines, from a candidate picture library storing candidate pictures marked with tags, a candidate picture marked with a tag that matches the at least one to-be-recommended tag as a target picture, according to the at least one to-be-recommended tag; and sends the target picture to the electronic device. This can intelligently provide the user with more favorite pictures according to the user's preference.

In addition, an embodiment of the present application further provides an application program which, when executed, performs the picture processing method described in the embodiments of the present application. The picture processing method provided by the embodiment of the present application can include:

receiving at least one to-be-recommended tag sent by an electronic device, wherein the at least one to-be-recommended tag is configured for identifying content of at least one reference picture, and a predetermined favorite operation has been performed on the at least one reference picture by a user;

determining, from a candidate picture library storing candidate pictures marked with tags, a candidate picture marked with a tag that matches the at least one to-be-recommended tag as a target picture, according to the at least one to-be-recommended tag, wherein the tags are configured for identifying content of the candidate pictures; and

sending the target picture to the electronic device.

In the embodiment of the present application, the server first receives at least one to-be-recommended tag sent by the electronic device, determines, from a candidate picture library storing candidate pictures marked with tags, a candidate picture marked with a tag that matches the at least one to-be-recommended tag as a target picture, according to the at least one to-be-recommended tag; and sends the target picture to the electronic device. This can intelligently provide the user with more favorite pictures according to the user's preference.

For the embodiments of the apparatus, the electronic device, the storage medium and the application program, since they are basically similar to the method embodiments, the description is relatively simple. For related parts, reference may be made to the parts of the description of the method embodiments.

It should be noted that, the relationship terms herein such as “first”, “second” and the like are only used to distinguish one entity or operation from another entity or operation, but do not necessarily require or imply that there is actual relationship or order between these entities or operations. Moreover, the terms “include”, “comprise” or any variants thereof are intended to cover a non-exclusive inclusions, such that processes, methods, articles, or devices comprising a series of elements comprise not only those elements listed but also those not specifically listed or the elements intrinsic to these processes, methods, articles, or devices. Without further limitations, elements defined by the sentences “comprise(s) a . . . ” or “include(s) a . . . ” do not exclude that there are other identical elements in the processes, methods, articles, or devices which comprise these elements.

It should be noted, for simplicity, the foregoing method embodiments are all expressed as a combination of a series of actions. However, those skilled in the art should understand that the present application is not limited by the described sequence of actions, because certain steps may be performed in other sequences or simultaneously according to the present application. Those skilled in the art should also understand that the embodiments described in the specification are preferred embodiments, and the involved actions and modules may not be necessary in the present application.

In the above embodiments, the description for each embodiment focuses on the differences from other embodiments. For the part not described in detail in one embodiment, reference may be made to the relevant description of other embodiments.

It should be understood that the disclosed apparatus in several embodiments herein may be implemented in other ways. For example, the apparatus embodiments described above are schematic. For example, the division of the units is only one kind of logical function division. In actual implementation, there may be other divisions. For example, multiple units or components may be combined or may be integrated into another system, or some features may be omitted or not performed. In addition, the illustrated or discussed “coupling” or “direct coupling” or “communication connection” may indicate that a device or unit is indirectly coupled or communicated with another device or unit through some interfaces, for example, electrically or in other forms.

The units described as separate parts may or may not be physically separated, and the parts illustrated as units may or may not be physical units, that is, they may either be located in one place, or be distributed over the network. Some or all of the units may be selected according to actual needs to achieve the purpose of the solution of the embodiments.

In addition, all functional units in each embodiment of the present application may be integrated in one processing unit, or each unit may exist alone physically, or two or more units may be integrated in one unit. The above integrated unit can be implemented either as hardware or as software functional unit.

The integrated unit, if implemented in the form of a software functional unit and sold or used as a stand-alone product, may be stored in a computer-readable storage medium. Based on such understanding, the essential part of the technical solution of the present application, or the part that contributes to the prior art, or all or part of the technical solution can be embodied in the form of a software product. The computer software product is stored in a storage medium and includes instructions for causing a computer device (which may be a personal computer, a server, or a network device, etc.) to perform all or some steps of the method described in each embodiment of the present application. The foregoing storage medium includes: a U disk, a Read-Only Memory (ROM), a Random Access Memory (RAM), a mobile hard disk, a magnetic disk, an optical disk, or any other medium that can store program code.

The above embodiments are only used to illustrate, but not to limit, the technical solutions of the present application. Although the present application has been described in detail with reference to the foregoing embodiments, those of ordinary skills in the art should understand that the technical solutions described in the foregoing embodiments can be modified, or some of the technical features therein can be equivalently substituted, if these modifications or substitutions do not deviate from the scope of the technical solutions of the embodiments of the present application.

1. A picture processing method, which is applicable to an electronic device, comprising:
traversing a stored preset picture library to determine a tag for each of at least one reference picture in the preset picture library, wherein the tag is configured for identifying content of the reference picture, and a predetermined favorite operation has been performed on the at least one reference picture by a user;
determining at least one to-be-recommended tag from the determined tags according to a preset selecting rule;
sending the at least one to-be-recommended tag to a server, which is configured to provide a target picture to the electronic device; and
receiving and displaying a target picture that is provided by the server to the electronic device based on the at least one to-be-recommended tag.

2. The method of claim 1, wherein before traversing a stored preset picture library, the method further comprises:
obtaining, from a local picture library, at least one reference picture on which the predetermined favorite operation has been performed by the user, wherein the predetermined favorite operation includes an operation of giving a like and/or the number of times that a picture is opened exceeding a threshold; and
storing the at least one reference picture into the preset picture library.

3. The method of claim 1, wherein before traversing a stored preset picture library, the method further comprises:
extracting reference target content of the at least one reference picture in the preset picture library;
determining a tag for the reference target content of each of the at least one reference picture based on a preset correspondence between target content and tags; and
marking each of the at least one reference picture with the tag.

4. The method of claim 1, wherein before traversing a stored preset picture library, the method further comprises:
extracting reference target content of the at least one reference picture in the preset picture library;
matching the reference target content of each of the at least one reference picture with preset picture content for preset picture categories in a preset picture category database;
determining a preset picture category for preset picture content that matches the reference target content of each of the at least one reference picture as a picture category of the reference picture; and
marking each of the at least one reference picture with a tag corresponding to the determined picture category.

5. The method of claim 1, wherein determining at least one to-be-recommended tag from the determined tags according to a preset selecting rule, comprises:
categorizing and counting the at least one reference picture in the preset picture library according to the tags for the at least one reference picture in the preset picture library to obtain the number of pictures in each tag; and
determining a tag in which the number of pictures exceeds a predetermined threshold as the at least one to-be-recommended tag.

6. The method of claim 5, wherein after determining a tag in which the number of pictures exceeds a predetermined threshold as the at least one to-be-recommended tag, the method further comprises:
determining a tag-level of each of the at least one to-be-recommended tag according to the number of pictures in this to-be-recommended tag, wherein the number of pictures in each of the at least one to-be-recommended tag is proportional to the tag-level of this to-be-recommended tag; and
sending the tag-level of each of the at least one to-be-recommended tag to the server.

7. The method of claim 1, wherein the tag comprises:
at least one of a human tag, a landscape tag, an animal tag, a thing tag, an event tag, a geographical location tag, and a generation time tag.

8. A picture processing method, which is applicable to a server, comprising:
receiving at least one to-be-recommended tag sent by an electronic device, wherein the at least one to-be-recommended tag is configured for identifying content of at least one reference picture, and a predetermined favorite operation has been performed on the at least one reference picture by a user;
determining, from a candidate picture library storing candidate pictures marked with tags, a candidate picture marked with a tag that matches the at least one to-be-recommended tag as a target picture, according to the at least one to-be-recommended tag, wherein the tags are configured for identifying content of the candidate pictures; and
sending the target picture to the electronic device.

9. The method of claim 8, wherein before determining, from a candidate picture library storing candidate pictures marked with tags, a candidate picture marked with a tag that matches the at least one to-be-recommended tag as a target picture, the method further comprises:
obtaining a candidate picture;
extracting reference target content of the candidate picture;
determining a tag for the reference target content of the candidate picture based on a preset correspondence between target content and tags; and
marking the candidate picture with the determined tag.

10. The method of claim 8, wherein before determining, from a candidate picture library storing candidate pictures marked with tags, a candidate picture marked with a tag that matches the at least one to-be-recommended tag as a target picture, the method further comprises:
obtaining a candidate picture;
extracting reference target content of the candidate picture;
matching the reference target content of the candidate picture with preset picture content for preset picture categories in a preset picture category database;
determining a preset picture category for preset picture content that matches the reference target content of the candidate picture as a picture category of the candidate picture; and
marking the candidate picture with a tag corresponding to the determined picture category.

11. The method of claim 8, wherein the method further comprises:
receiving a tag-level of each of the at least one to-be-recommended tag sent by the electronic device; and
determining, from a candidate picture library storing candidate pictures marked with tags, a candidate picture marked with a tag that matches the at least one to-be-recommended tag as a target picture, according to the at least one to-be-recommended tag, comprises:
according to the at least one to-be-recommended tag and the tag-level of each of the at least one to-be-recommended tag, determining, from the candidate picture library storing candidate pictures marked with tags, a candidate picture marked with a tag that matches at least one to-be-recommended tag with a tag-level greater than a predetermined tag-level as a target picture.

12. The method of claim 8, wherein the method further comprises:
receiving a tag-level of each of the at least one to-be-recommended tag sent by the electronic device; and
the target picture comprises a plurality of target pictures, and sending the target picture to the electronic device comprises:
determining, according to the tag-level of each of the at least one to-be-recommended tag, an order that the target pictures are sent;
sending the target pictures to the electronic device according to the order.

13-23. (canceled)

24. An electronic device, comprising: a housing, a processor, a memory, a circuit board, and a power supply circuit, wherein the circuit board is arranged inside a space enclosed by the housing; the processor and the memory are arranged on the circuit board;
the power supply circuit is configured to supply power to various circuits or components of the electronic device; the memory is configured to store executable program code; the processor executes a program corresponding to the executable program code by reading the executable program code stored in the memory, so as to perform a picture processing method comprising:
traversing a stored preset picture library to determine a tag for each of at least one reference picture in the preset picture library, wherein the tag is configured for identifying content of the reference picture, and a predetermined favorite operation has been performed on the at least one reference picture by a user;
determining at least one to-be-recommended tag from the determined tags according to a preset selecting rule;
sending the at least one to-be-recommended tag to a server, which is configured to provide a target picture to the electronic device; and
receiving and displaying a target picture that is provided by the server to the electronic device based on the at least one to-be-recommended tag.

25. A non-transitory storage medium configured for storing an application program which, when executed, performs the picture processing method of claim 1.

26. (canceled)

27. A server, comprising: a housing, a processor, a memory, a circuit board, and a power supply circuit, wherein the circuit board is arranged inside a space enclosed by the housing; the processor and the memory are arranged on the circuit board; the power supply circuit is configured to supply power to various circuits or components of the server; the memory is configured to store executable program code; and the processor executes a program corresponding to the executable program code by reading the executable program code stored in the memory, so as to perform the picture processing method of claim 8.

28. A non-transitory storage medium configured for storing an application program which, when executed, performs the picture processing method of claim 8.

29. (canceled)

30. The electronic device of claim 24, wherein before traversing a stored preset picture library, the method further comprises:
obtaining, from a local picture library, at least one reference picture on which the predetermined favorite operation has been performed by the user, wherein the predetermined favorite operation includes an operation of giving a like and/or the number of times that a picture is opened exceeding a threshold; and
storing the at least one reference picture into the preset picture library;
or wherein, before traversing a stored preset picture library, the method further comprises:
extracting reference target content of the at least one reference picture in the preset picture library;
determining a tag for the reference target content of each of the at least one reference picture based on a preset correspondence between target content and tags; and
marking each of the at least one reference picture with the tag;
or wherein, before traversing a stored preset picture library, the method further comprises:
extracting reference target content of the at least one reference picture in the preset picture library;
matching the reference target content of each of the at least one reference picture with preset picture content for preset picture categories in a preset picture category database;
determining a preset picture category for preset picture content that matches the reference target content of each of the at least one reference picture as a picture category of the reference picture; and
marking each of the at least one reference picture with a tag corresponding to the determined picture category.

31. The electronic device of claim 24, wherein determining at least one to-be-recommended tag from the determined tags according to a preset selecting rule, comprises:
categorizing and counting the at least one reference picture in the preset picture library according to the tags for the at least one reference picture in the preset picture library to obtain the number of pictures in each tag; and
determining a tag in which the number of pictures exceeds a predetermined threshold as the at least one to-be-recommended tag.

32. The electronic device of claim 31, wherein after determining a tag in which the number of pictures exceeds a predetermined threshold as the at least one to-be-recommended tag, the method further comprises:
determining a tag-level of each of the at least one to-be-recommended tag according to the number of pictures in this to-be-recommended tag, wherein the number of pictures in each of the at least one to-be-recommended tag is proportional to the tag-level of this to-be-recommended tag; and
sending the tag-level of each of the at least one to-be-recommended tag to the server.

33. The electronic device of claim 24, wherein the tag comprises:
at least one of a human tag, a landscape tag, an animal tag, a thing tag, an event tag, a geographical location tag, and a generation time tag.
